(19) United States
(12) Patent Application Publication
(10) Pub. No.: US 2025/0117137 A1
(43) Pub. Date: Apr. 10, 2025

(54) SELF-OPTIMIZATION OF DATA PLACEMENT IN MEMORY OR STORAGE SYSTEMS

(71) Applicant: MICRON TECHNOLOGY, INC., Boise, ID (US)

(72) Inventors: Jay Sarkar, San Jose, CA (US); David Scott Ebsen, Minnetonka, MN (US); Aaron Lucas, Boulder, CO (US); Seyhan Karakulak, San Jose, CA (US); Saeed Sharifi Tehrani, San Diego, CA (US)

(21) Appl. No.: 18/905,398

(22) Filed: Oct. 3, 2024

Related U.S. Application Data
(60) Provisional application No. 63/542,377, filed on Oct. 4, 2023.

(51) Int. Cl. G06F 3/06

(52) U.S. Cl. CPC G06F 3/0613; G06F 3/064; G06F 3/0679

(57) ABSTRACT

Systems and methods are disclosed including a memory and a processing device operatively coupled to the memory. The processing device can perform operations including identifying a set of logical addresses associated with data stored on the memory devices in one or more blocks of a first type; determining a temporal metric class associated with the set of logical addresses, wherein the temporal metric class is associated with a corresponding range of predicted update characteristic of the data; identifying, based on the temporal metric class, a set of blocks of a second type, wherein a first block of the first type comprises a first plurality of memory cells having a first number of bits per cell, and wherein a second block of the second type comprises a second plurality of memory cells having a second number of bits per cell that exceeds the first number of bits per cell; and moving the data to the identified set of blocks.

### RELATED APPLICATIONS

This application claims the benefit of U.S. Provisional Application No. 63/542,377, filed Oct. 4, 2023, which is incorporated herein by reference.

### TECHNICAL FIELD

Embodiments of the disclosure relate generally to memory sub-systems, and more specifically, relate to self-optimization of data placement in memory or storage systems.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The present disclosure will be understood more fully from the detailed description given below and from the accompanying drawings of various embodiments of the disclosure.

FIG. 1 illustrates an example computing system that includes a memory sub-system in accordance with some embodiments of the present disclosure.

FIGS. 2-3 illustrate example system architectures that include memory device using a data placement component in accordance with some embodiments of the present disclosure.

FIG. 4 illustrates example data placement in accordance with aspects of the present disclosure.

FIG. 5 is a flow diagram of an example method of training machine learning models for use in data placement in accordance with some embodiments of the present disclosure.

FIG. 6 is a flow diagram of an example method of using trained machine learning models for use in data placement in accordance with some embodiments of the present disclosure.

FIG. 7 is a block diagram of an example computer system in which embodiments of the present disclosure can operate.

### DETAILED DESCRIPTION

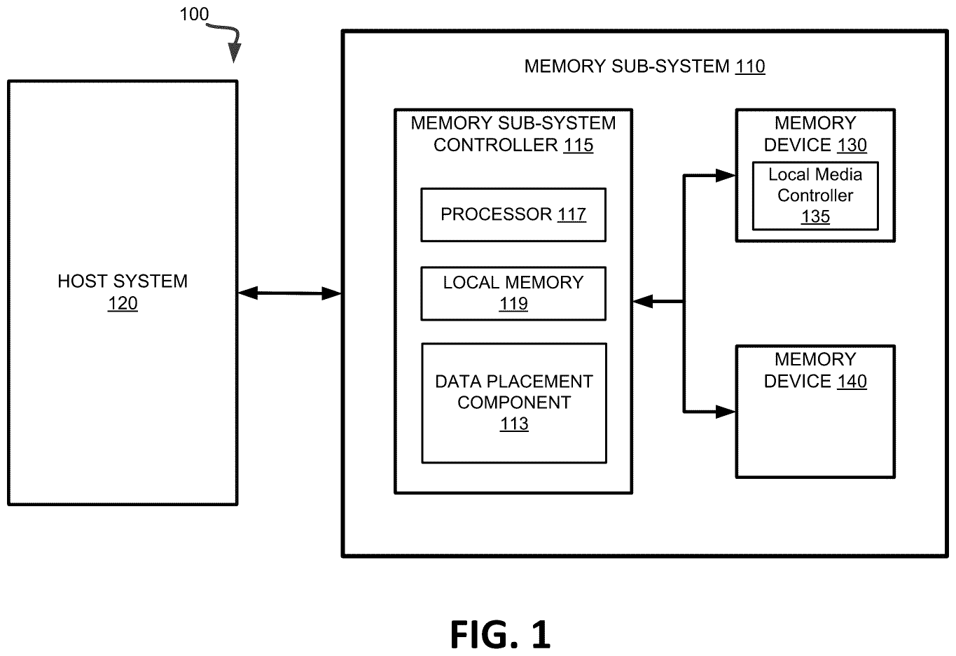

Aspects of the present disclosure are directed to self-optimization of data placement in memory or storage systems. A memory sub-system can be a storage device, a memory module, or a hybrid of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A memory sub-system can utilize one or more memory devices, including any combination of the different types of non-volatile memory devices and/or volatile memory devices, to store the data provided by the host system. Each of the memory devices can include one or more arrays of memory cells. A memory cell (“cell”) is an electronic circuit that stores information. Depending on the cell type, a cell can store one or more bits of binary information, and has various logic states that correlate to the number of bits being stored. The logic states can be represented by binary values, such as “0” and “1”, or combinations of such values.

Various data operations can be performed by the memory sub-system. The data operations can be host-initiated operations. For example, the host system can initiate a data operation (e.g., write, read, erase, etc.) on a memory sub-system. The host system can send access requests (e.g., write command, read command) to the memory sub-system, such as to store data on a memory device at the memory sub-system and to read data from the memory device on the memory sub-system. The data to be read or written, as specified by a host request, is hereinafter referred to as “host data.” A host request can include logical address information (e.g., logical block address (LBA), namespace) for the host data, which is the location the host system associates with the host data. The logical address information (e.g., LBA, namespace) can be part of metadata for the host data. Metadata can also include error-handling data (e.g., error correction code (ECC) codeword parity data), data version (e.g., used to distinguish age of data written), valid bitmap (which LBAs or logical transfer units contain valid data), etc.

A memory device can be a non-volatile memory device. A non-volatile memory device is a package of one or more dice. Each die can consist of one or more planes. For some types of non-volatile memory devices (e.g., negative-and (NAND) devices), each plane consists of a set of physical blocks. Each block consists of a set of pages. Each page consists of a set of memory cells, which store bits of data. For some memory devices, such as NAND devices, blocks are the smallest area that can be erased. A block can contain valid data, invalid data, or no data. Invalid data is data that is marked as outdated as a new version of the data is stored on the memory device. Invalid data includes data that was previously written but is no longer associated with a valid logical address, such as a logical address referenced by a host system in a physical to logical (P2L) mapping table. Valid data is the most recent version of such data being stored on the memory device. A memory sub-system can mark data as invalid based on information received, for example, from an operating system.

A memory sub-system controller can perform operations for media management operations, such as wear leveling, refresh, garbage collection, scrub, etc. A block may have some pages containing valid data and some pages containing invalid data. To avoid waiting for all of the pages in the block to have invalid data in order to erase and reuse the block, an algorithm hereinafter referred to as “garbage collection” can be invoked to allow the block to be erased and released as a free block for subsequent write operations. Garbage collection is a set of media management operations that include, for example, selecting a block that contains valid and invalid data, selecting pages in the block that contain valid data, copying the valid data to new locations (e.g., free pages in another block), marking the data in the previously selected pages as invalid, and erasing the selected block. Garbage collection hereinafter refers to selecting a block, rewriting the valid data from the selected block to another block, and erasing all invalid data and valid data stored at the selected block. The valid data from multiple selected blocks can be copied to a smaller number of other blocks and the selected blocks can then be erased. As a result, the number of blocks that have been erased can be increased such that more blocks are available to store subsequent data from a host system. A memory sub-system can implement a garbage collection operation to maintain or generate a continuous supply of free data blocks to host applications for storing data.

As described above, garbage collection is an operation to copy valid data from one data block to another data block, and the source data block (e.g., the data block that the valid data is copied from) can then be erased and released as a free block for subsequent host writes. This additional re-write of valid data in the data blocks during a garbage collection operation results in write amplification. Write amplification can reduce the operating life and impact performance of the memory sub-system.

The write amplification factor (WAF) is the ratio of the number of write operations that occur within the memory sub-system compared to the number of write operations that are received from the host system. For example, a WAF of five indicates that for every write operation received from the host system, the memory sub-system performs four additional back-end write operations related to media management. Furthermore, data exhibiting lower values of a chosen temporal metric (e.g., referred to as low-temporal-metric data) can be stored on the same memory block as data exhibiting higher values of the chosen temporal metric value (e.g., high-temporal-metric or medium-temporal-metric data). The temporal metric can reflect, e.g., the time elapsed since the most recent access to the data, the frequency of updates of the data, etc. Unchanged low-temporal-metric data that is located on the same blocks as high-temporal-metric data is likely to be copied to new blocks numerous times by garbage collection operations because of changes to the high-temporal-metric data located on the same blocks. Since low-temporal-metric data is unlikely to change, repeatedly writing and re-writing the low-temporal-metric data during garbage collection operations increases the WAF of the memory sub-system.

Memory devices can include one or more arrays of memory cells such as single-level cell (SLC) memory, multi-level cell (MLC) memory, triple-level cell (TLC) memory, or quad-level cell (QLC) memory. Each type can have a different data density, which corresponds to an amount of data (e.g., bits of data) that can be stored per memory cell of a memory device. Using the example of a flash based memory, a quad-level cell (QLC) can store four bits of data while a single-level cell (SLC) can store one bit of data. Accordingly, a memory device including QLC memory cells will have a higher data density than a memory device including SLC memory cells. Additionally, each type of memory cell can have different endurance for storing data. The endurance of the memory device is the number of write operations or a number of program/erase operations performed on a memory cell of the memory device before data can no longer be reliably stored at the memory cell. For example, SLC memory cells that have a lower data density can have higher endurance threshold than QLC memory cells that have a higher data density.

Some memory devices use certain types of high density memory cells, such as quad-level cell (QLC) memory cells that store four bits of data in each memory cell. QLC memory is particularly well-suited for read-intensive workloads, often seen in data center applications where data is normally generated once, and then read regularly to perform calculations and analysis. A memory sub-system can allocate a set of SLC blocks as a cache to initially program the SLC blocks with the data to be written to the QLC blocks. Thereafter, the data may be moved from the SLC cache to QLC memory for longer-term storage.

Aspects of the present disclosure improve efficiency of memory access operations by implementing a system capable of determining a temporal metric class associated with data cached in the SLC blocks of a memory device and moving the data to groups of the non-SLC (e.g., QLC) blocks of the memory device according to the temporal metric class of the data. The temporal metric class reflects the update characteristic (e.g., frequency of updates) of the data and may be associated with a corresponding range of predicted update characteristic (e.g., update frequencies) of the data. In one example, the data can be represented using the address information (e.g., LBAs), and the temporal metric class of the data can be labelled as a the temporal metric class according to the frequency of update of the data stored on the address (e.g., a frequency over a threshold value, or a frequency below a threshold value). In some implementations, the temporal metric class can reflect the time elapsed since the most recent update to the data. In one example, the temporal metric classification is binary including a short temporal metric class and a long temporal metric class. The short temporal metric class may be associated with the frequency of updates of the data exceeding a threshold value (e.g., high frequency), while the long temporal metric class may be associated with the frequency of updates of the data not exceeding a threshold value (e.g., low frequency). Alternatively, or additionally, the short temporal metric class may be associated with the elapsed time below a threshold value, and the long temporal metric class may be associated with the elapsed time above the threshold value.

As another example, the temporal metric class is one of the multiple classes, including a short temporal metric class, one or more medium temporal metric classes, and a long temporal metric class. The short temporal metric class may be associated with data update frequency exceeding a first threshold value, the long temporal metric class may be associated with data update frequency not exceeding a second threshold value, and the one or more medium temporal metric classes may be associated with the data update frequency falling in between the first threshold value and the second threshold value. Alternatively, or additionally, the short temporal metric class may be associated with the elapsed time below a first threshold value, the long temporal metric class may be associated with the elapsed time above a second threshold value, and the one or more medium temporal metric classes may be associated with the elapsed time falling in between the first threshold value and the second threshold value.

A group of the non-SLC blocks of the memory device refers to a set of continuous non-SLC blocks that are used to store data in the same temporal metric class, and in some implementations, can be referred to as a superblock. Although the data movement is described as from the SLC blocks to the non-SLC blocks, the data movement may occur from a block of a first type to a block of a second type, where the block of the first type includes memory cells having a first number of bits per cell, and the block of the second type includes memory cells having a second number of bits per cell that exceeds the first number of bits per cell. For example, the data movement can occur from the SLC blocks to at least one of MLC, TLC, QLC, etc. blocks. As another example, the data movement can occur from the MLC blocks to at least one of TLC, QLC, etc. blocks.

The data stored in the SLC blocks may be specific to a type of workload, for example, hard disk drive (HDD) experienced workload, solid-state drive (SSD) experienced workload, dynamic random access memory (DRAM) experienced workload, etc. The type of workload refers to workload following a write/read pattern that is suitable for a specific type of memory device. The type of memory device may depend on the serving purpose of the memory device to a host system. A same type of workload includes workload following the write/read pattern that is suitable for a same type of memory device. The HDD experienced workload may include read-intensive workloads, e.g., in data center applications, where data is normally generated once, and then read regularly to perform calculations and analysis. The SSD experienced workload may include write-intensive workloads, where data is normally updated (e.g., overwritten) regularly. The DRAM experienced workload may include the write-intensive and read-intensive workloads, such as the workload in the main memory of a host system. The workload may also include the workload transmitted between the different types of memory devices though the compute express link (CXL) bus.

Determining the temporal metric class may be performed through a trained machine learning model (MLM). The MLM may be trained using historical data of a workload type matching the workload type of the data to be used for inferencing. For example, to determine frequency of updates classification for data in an HDD experienced workload, the MLM is trained using historical data of HDD experienced workloads. As another example, to determine frequency of updates classification for data in an SSD experienced workload, the MLM is trained using the historical data of SSD experienced workloads.

Specifically, a data placement component coupled with the memory device may obtain a set of logical addresses (e.g., range of LBAs) of data cached in the SLC blocks of the memory device. The data placement component may feed the address information to the trained MLM, which may produce a respective temporal metric class associated with the addresses. The memory device may then store the data from the SLC blocks in the groups (e.g., superblocks) of the non-SLC blocks according to the respective temporal metric class. For example, assuming that the first LBA range is determined to be associated with the short temporal metric class, the second LBA range is determined to be associated with the long temporal metric class, and the third LBA range is determined to be associated with the short temporal metric class, the memory device may store the data of the first LBA range and the data of the third LBA range in the same group of the non-SLC blocks, while storing the data of the second LBA in a different group of the non-SLC blocks. As another example, assuming that the first set of LBAs is determined to be associated with the short temporal metric class, the second set of LBAs is determined to be associated with the medium temporal metric class, and the third set of LBAs is determined to be associated with the long temporal metric class, the memory device may store the data of the first set of LBAs, the data of the second set of LBAs, and the data of the third set of LBAs in different groups of the non-SLC blocks.

To train the MLM, historical data may be collected. In some implementations, a tiered storage stack is used for collecting the training data. For example, the tiered storage stack may include a first tier memory device such as DRAM, a second tier memory device such as SSD, and a third tier memory device such as HDD. Specifically, data of a specific workload type (e.g., HDD experienced workload) is supplied to the tiered storage stack, and the tiered storage stack performs storage tiering by moving data across tiers to relocate low-temporal-metric data to lower cost, higher capacity storage, for example, from the first tier memory device to the second tier memory device, and/or from the second tier memory device to the third tier memory device. For example, the data placement component may track the data movement from the second tier memory device to the third tier memory device, for example, by recording the metadata (e.g., address information) of data kept in the second tier memory device and the data moved to the third tier memory device. In such case, data that has been moved from the second tier memory device to the third tier memory device may represent low-temporal-metric data and can be annotated as such, while the data that is kept in the second tier memory device may represent high-temporal-metric data and can be annotated as such. The data placement component may generate the training data including training input and expected training output using the tracked data described above. The training input includes the LBAs of the tracked data and the training output includes the annotation metadata that indicates the classes of the LBAs of the tracked data. The data placement component may provide the training data to the MLM, and the MLM may classify the LBAs and compare the classification with the annotation metadata to determine parameters of the MLM.

Advantages of the present disclosure include an improved data placement of the memory sub-system by grouping data stored in the SLC blocks according to access frequency to have data placed in the non-SLC (e.g., QLC) blocks optimized. The data placement optimization can be specific to workloads or customers. This can result in an improvement of performance of the memory sub-system and a decrease in write amplification. Furthermore, this can increase the lifespan of the memory sub-system. Also, the data placement optimization can apply to the systems using tiered storage stack. Although embodiments are described using certain memory cells of a NAND flash memory, aspects of the present disclosure can be applied to other types of memory sub-systems and other types of memory cells (e.g., MLC, TLC, etc.).

FIG. 1 illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to different types of memory sub-system 110. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the physical host interface (e.g., PCIe bus). The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include negative-and (NAND) type flash memory and write-in-place memory, such as a three-dimensional cross-point (“3D cross-point”) memory device, which is a cross-point array of non-volatile memory cells. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 130 can include one or more arrays of memory cells such as SLCs, MLCs, TLCs, QLCs, PLCs or any combination of such. In some embodiments, a particular memory device can include an SLC portion, and an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as 3D cross-point array of non-volatile memory cells and NAND type flash memory (e.g. 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, and electrically erasable programmable read-only memory (EEPROM).

The memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can be a processing device, which includes one or more processors (e.g., processor 117), configured to execute instructions stored in local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical MU address, physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, memory sub-system 110 is a managed memory device, which includes a raw memory device 130 having control logic (e.g., local controller) on the die and a controller (e.g., memory sub-system controller 115) for media management within the same memory device package. An example of a managed memory device is a managed NAND (MNAND) device.

The memory sub-system 110 includes a data placement component 113 that can place data associated with a workload to a storage that represents an optimized storage for the workload. In some embodiments, the memory sub-system 110 includes at least a portion of the data placement component 113. For example, the memory sub-system controller 115 can include a processor 117 (processing device) configured to execute instructions stored in local memory 119 for performing the operations described herein. In some embodiments, the data placement component 113 is part of the host system 120, an application, or an operating system. The data placement component 113 is described in more detail herein below.

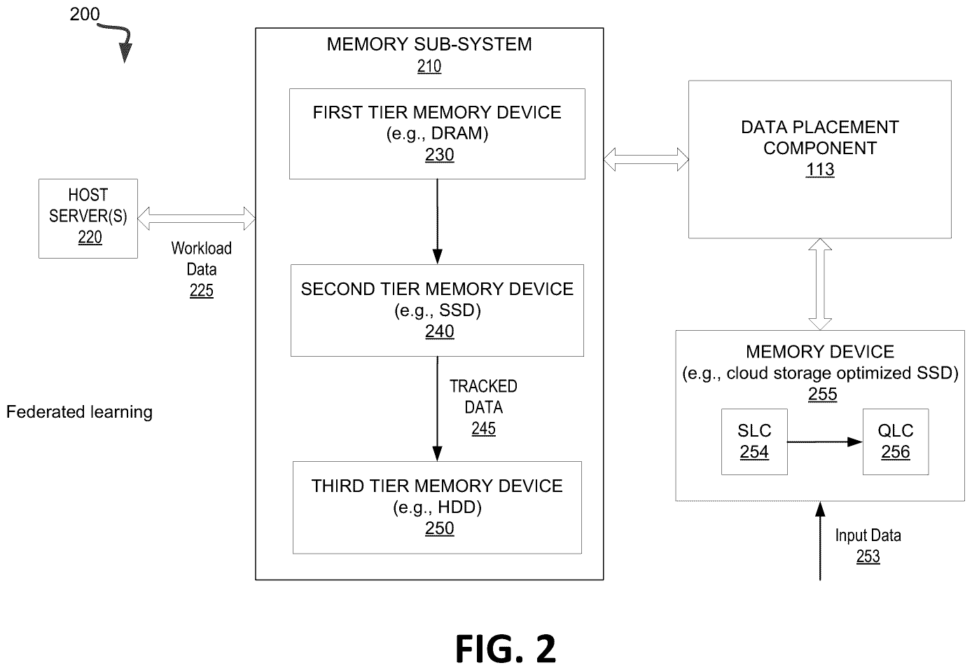

FIG. 2 illustrates an example system architecture 200 that includes host server(s) 220 using memory sub-system(s) 210 in accordance with some embodiments of the present disclosure. System architecture 200 includes memory sub-system 210, one or more host servers 220, memory device 255, and data placement component 113. In some implementations, the memory sub-system 210 is the same as the memory sub-system 110. In some implementations, the host server 220 is the same as the host system 120. In some implementations, the memory device 255 is in a type that can be used to replace a third tier memory device (e.g., the third tier memory device 250) for certain workloads.

The host server 220 may be a desktop computer, a laptop computer, a smartphone, a tablet computer, or any suitable computing device capable of providing host services through different user interfaces, including applications, websites. In some implementations, the host server 220 provides workload 225 that is suitable for a type of a memory device (e.g., HDD, SSD, or DRAM).

The memory sub-system 210 may perform storage tiering and generate tracked data 245 by tracking the data movement through the storage tiers using workload 225. Storage tiering refers to a process that moves each data object (or file) to the most appropriate storage tier based on its access frequency. For example, the memory sub-system 210 may include a first tier memory device 230, a second tier memory device 240, and a third tier memory device 250. When deciding the tier to store data, the memory sub-system 210 may consider the access patterns including the access frequency. In one example, high-temporal-metric data includes data that is accessed at a frequency exceeding a first threshold frequency (i.e., frequently), low-temporal-metric data includes data that is accessed at a frequency below a second threshold frequency (e.g., infrequently), and medium-temporal-metric data includes data that is accessed at a frequency falling in between the first threshold frequency and the second threshold frequency. In one example, high-temporal-metric data needs to be stored on faster storage, for instance, a solid state disk (SSD), medium-temporal-metric data can be stored on slower storage, for instance, hard drives, and low-temporal-metric data can be stored on the slowest storage, for instance, an inexpensive object storage service. In the example of FIG. 2, high-temporal-metric data can be stored on the first tier memory device 230 such as DRAM, medium-temporal-metric data can be stored on the second tier memory device 240 such as SSD, and low-temporal-metric data can be stored on the third tier memory device 250 such as HDD. Although the specific types of memory devices are illustrated in the memory sub-system 210 in FIG. 2, the memory sub-system 210 can include one or more CXL memory system. A CXL memory device refers to a memory device attached via a CXL bus and can provide additional bandwidth and capacity to host processors. For example, the first tier memory device 230 may be a DRAM attached via a CXL bus.

The memory sub-system 210 allows the data placement according to the storage tiering by moving data across tiers, for example, by relocating low-temporal-metric data to lower cost, higher capacity storage devices. For example, new files may be created in the hot storage tier (e.g., the first tier memory device 230), and if memory sub-system 210 determines that files have not been accessed for some period, the files are moved to a warm storage tier (e.g., the second tier memory device 240), and if files are still not accessed for a long time, files are eventually moved to a cold storage tier (e.g., the third tier memory device 250).

In some implementations, data involved in the data placement may be specific to workload of a customer and the workload may be associated with object stores, cloud storage, all-flash arrays, software defined storage (SDS) capacity tiers, or various rates of data acceptation and data analysis (e.g., faster ingest rate than analytic rate). In the example of FIG. 2, the workload 225 may be an HDD type of workload, and the memory sub-system 210 may move some data associated with the workload 225 from the first tier memory device 230 to the second tier memory device 240 and from the second tier memory device 240 to the third tier memory device 250. Specifically, a first set of data associated with the workload 225 may be accessed at a frequency below the first threshold frequency, and the memory sub-system 210 may move the first set of data from the first tier memory device 230 to the second tier memory device 240. After a period, the first set of data may be accessed at a frequency below the second threshold frequency that is lower than the first threshold frequency, and the memory sub-system 210 may move the first set of data from the second tier memory device 240 to the third tier memory device 250. In this example, the first set of data is tracked as data 245 and can be used for training the machine learning models (MLMs).

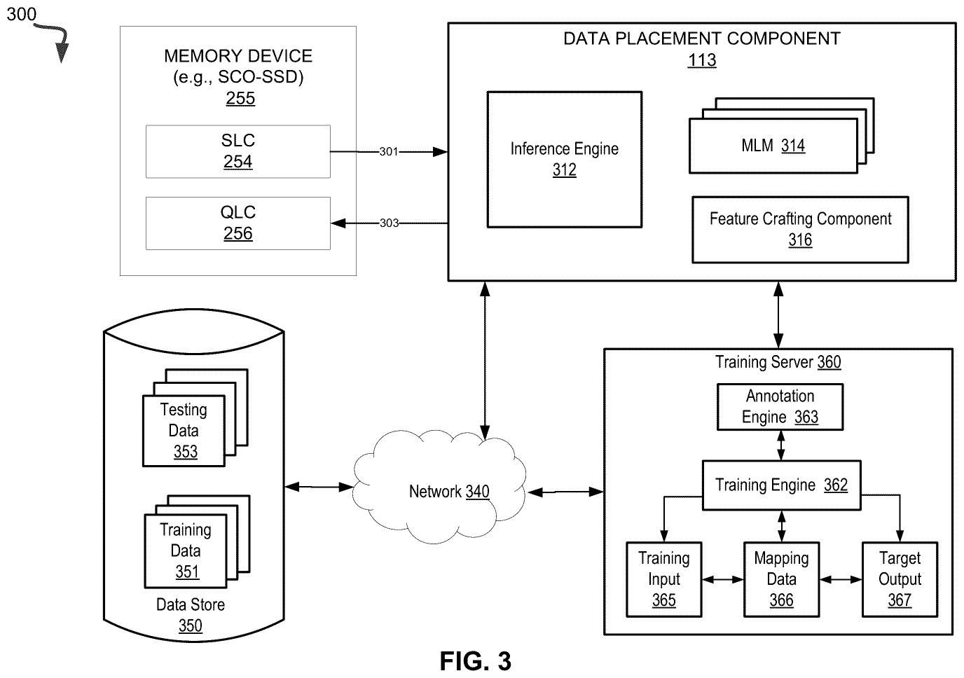

The data placement component 113 may perform storage optimization using machine learning (e.g., trained MLM) to effectively optimize the storage for a specific customer environment including workload. In the example of FIG. 2, the data placement component 113 may track the data 245, use the tracked data 245 to train a MLM, for example, by the method 500, and implement the trained MLM, for example, by the method 600. In some implementations, the data 245 may include a LBA (or a range of LBAs) and information indicating whether the LBA has been overwritten and moved to the third tier memory device 250. In some implementations, the data 245 may include a LBA (or a range of LBAs) and information indicating whether the LBA corresponds to a short or long temporal metric class. In some implementations, the data 245 may be processed with domain knowledge to craft the features (e.g., through the feature crafting component 316 in FIG. 3) to be fed into the MLMs. In some implementations, the crafted feature may include the size of the data written to the LBA. For example, assuming the LBA is LBA 1, where the block size addressed by one LBA is in a unit block size, and the size of the data written to the LBA 1 may be a 6-block size, the LBA 1-LBA 7 may be annotated as corresponding to a same temporal metric class. In some implementations, the crafted feature may include time information regarding writing and/or overwriting associated with the LBA. For example, assuming the LBA is LBA 1, at time T1, the LBA 1 has been written, and at time T2, the LBA 1 has been overwritten, the time difference between T1-T2 may be used to determine whether the LBA 1 corresponds to a short or long temporal metric class.

The data placement component 113 may include a training engine (e.g., the training engine 362 in FIG. 3) to train one or more MLMs and save the trained MLMs (e.g., MLMs 314 in FIG. 3). The term engine herein refers to a hardware machine or a software component that is used to perform the operations associated with the specific (e.g., training, annotation, interface, etc.) functions. The set of MLMs may refer to model artifacts that are created using the training data that includes training inputs and corresponding target outputs (correct answers for respective training inputs). The trained MLMs may be stored by being inserted into the flash translation layer (FTL) as migration logic. While the FTL provides mapping of the LBAs to the physical address of the memory device, the migration logic can modify the mapping of the LBAs to the physical address of the memory device while the data is moved from SLC blocks to QLC blocks as described below. In one implementation, the data placement component 113 may be included in the memory sub-system 210. In one implementation, the data placement component 113 may be included in the memory device 255. The details of machine learning models are described below with respect to FIG. 3.

Although some specifications are illustrated above, it should be understood that the number and type of models that are used and the arrangement of such models can be modified to achieve the same or similar end results according to the aspects of the present disclosure. In some embodiments, one or more models are used to perform one or more of the optimization tasks, for example, optimization for different workloads and/or different memory devices. Each task may be performed by a separate model. Alternatively, a single model may perform each of the tasks or a subset of the tasks. Additionally, or alternatively, different models may be used to perform different combinations of the tasks.

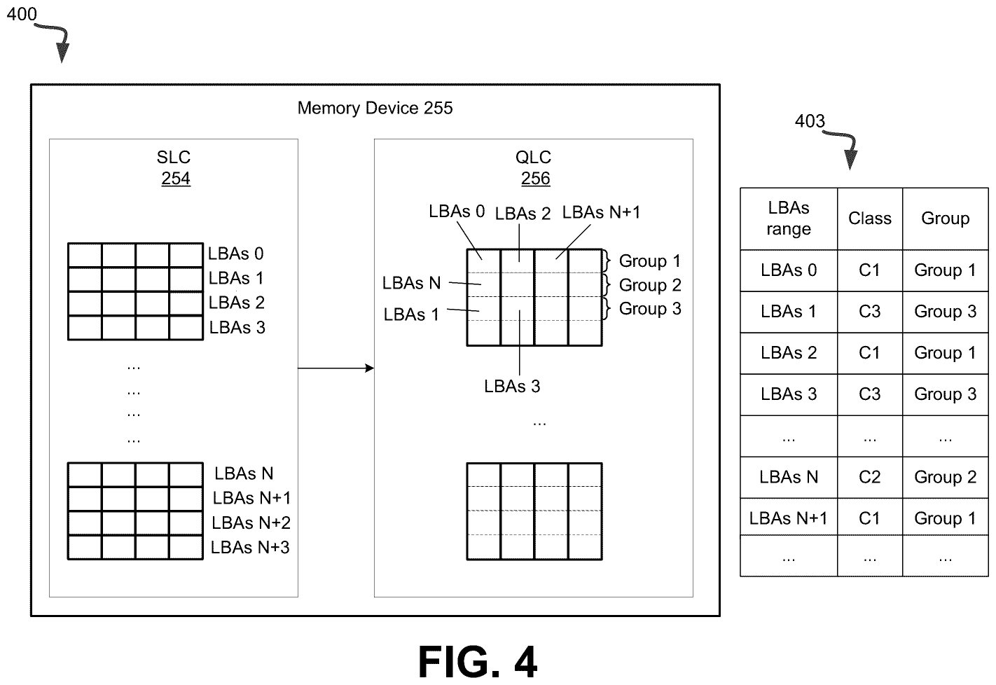

The data placement component 113 may communicate with the memory device 255 regarding the trained MLM. The data placement component 113 may communicate with memory device 255 for implementation of the trained MLM. Specifically, input data 253 may correspond to a specific workload, for example, similar to the workload 255, and the memory device 255 may store the input data 253 in one or more SLC blocks 254. The memory device 255 may obtain the LBAs of the input data 253 stored in one or more SLC blocks 254. The memory device 255 may apply the LBAs of the input data 253 to the trained MLM provided by the data placement component 113. The memory device 255 may receive a respective class associated with each LBA of the LBAs of the input data 253 and group the input data 253 in view of the respective classes. The memory device 255 may move the data from one or more SLC blocks 254 to one or more QLC blocks 246 by storing the input data 253 in the groups of one or more QLC blocks 246 according to the respective classes of the LBAs. A logical-to-physical (L2P) mapping data structure (e.g., L2P mapping table) maintains, for a number of logical addresses, a one-to-one mapping to respective physical addresses (e.g., a physical location of the SLC and/or QLC blocks). Accordingly, prior to programming of the QLC blocks, the L2P mapping table will include the physical address of the SLC blocks storing the data to be written to the QLC blocks. Once the QLC blocks are programmed, the L2P mapping table is updated to replace the physical address of the SLC blocks with the physical address of the QLC blocks. In some implementations, the memory device 255 can be used to replace the originally used third tier memory device 250. The details regarding the data placement from one or more SLC blocks 254 to one or more QLC blocks 246 are illustrated with respect to FIG. 4.

FIG. 3 illustrates an example system architecture 300 that includes a memory device 255 using the data placement component 113 to train MLMs and implement the trained MLMs, in accordance with some embodiments of the present disclosure. System architecture 300 includes a memory device 255, a data placement component 113, a data store 350, and a training server 360 connected to a network 340. Network 340 may be a public network (e.g., the Internet), a private network (e.g., a local area network (LAN), or wide area network (WAN)), a wireless network, a personal area network (PAN), or a combination thereof.

The memory device 255 may send data 301 (e.g., the LBAs) to the data placement component 113 for a classification of the data 301 so that the data 301 can be optimized placed from SLC blocks 254 to the QLC blocks 256. In response, the memory device 255 may receive the classification information 303 from the data placement component 113. In some implementations, the memory device 255 may use the classification information 303 to place the data in groups so that the data associated with short temporal metric class and data associated with long temporal metric class are placed in different groups in the QLC blocks 256.

The data store 350 may store training data 351 for training one or more machine learning models for data placement optimization and may store testing data 353 for testing one or more machine learning models for data placement optimization. The data store 350 can be accessed by data placement component 113 directly or (as shown) via network 340. The data store 350 may be a persistent storage capable of storing data as well as metadata for the stored data. The data store 350 may be hosted by one or more storage devices, such as main memory, magnetic or optical storage based disks, tapes or hard drives, network attached storage (NAS), storage area networks (SAN), and so forth. Although depicted as separate from data placement component 113, in at least one embodiment, the data store 350 may be a part of data placement component 113. In at least some embodiments, the data store 350 may be a network-attached file server, while in other embodiments, the data store 350 may be some other type of persistent storage such as an object-oriented database, a relational database, and so forth, that may be hosted by a server machine or one or more different machines coupled to the data placement component 113 via network 340.

The data placement component 113 may include a feature crafting component 316 to craft features of the data 301. The features of the data 301 may be used as additional information to train and use the MLMs. For example, the feature of the data 301 may include the time difference between data overwriting and data writing in an LBA. As another example, the feature of the data 301 may include the size of data associated with an LBA.

The data placement component 113 may include a memory communicatively coupled with one or more processing devices, such as one or more graphics processing units (GPU) and one or more central processing units (CPU). The memory can store one or more machine learning models (MLMs) 314.

The MLMs 314 may be trained by a training server 360. In at least one embodiment, training server 360 may be a part of data placement component 113. In other embodiments, training server 360 may be communicatively coupled to data placement component 113 directly or via network 340. Training server 360 may be (and/or include) a rackmount server, a router computer, a personal computer, a laptop computer, a tablet computer, a desktop computer, a media center, or any combination thereof. Training server 360 may include a training engine 362. In at least one embodiment, training engine 362 may generate one or more machine learning models (e.g., MLM 314). The generated machine learning models may be trained by training engine 362 using training data (e.g., training data 351) that may include training input(s) 365 and corresponding target output(s) 367. In at least one embodiment, different machine learning models can be trained separately for different types of workload (e.g., HDD experienced workload, or SSD experienced workload).

For training of MLM 314, training input(s) 365 may include training data and associated metadata. Training data may be tracked data 245. An annotation engine 363 may annotate the features in the tracked data 245 (e.g., according to the metadata of the tracked data 245) with classification of the LBAs and generate target output(s) 367, which may be target annotations of training input(s) 365. Additionally, training engine 362 may generate mapping data 366 (e.g., metadata) that associates training input(s) 365 with correct target output(s) 367. During training of MLM 314, training engine 362 may identify patterns in training input(s) 365 based on desired target output(s) 367 and train MLM 314 to perform the classification of the LBAs using the identified patterns.

In some implementations, the MLM 314 includes a neural network, and the neural network may be trained using training data. In at least one embodiment, each or some of MLMs 314 may include multiple neurons, and each neuron may receive its input from other neurons or from an external source and may produce an output by applying an activation function to the sum of (trainable) weighted inputs and a bias value. In at least one embodiment, each or some of MLMs 314 may include multiple neurons arranged in layers, including an input layer, one or more hidden layers, and an output layer. Neurons from adjacent layers may be connected by weighted edges. In at least one embodiment, weights may be chosen randomly or by pre-training using a deep belief network. In at least one embodiment, an untrained neural network is trained using supervised learning and processes inputs from training dataset and compares resulting outputs against a set of expected or desired outputs. In at least one embodiment, errors are then propagated back through untrained neural network. In at least one embodiment, training server 360 adjusts weights that control untrained neural network. In at least one embodiment, training server 360 includes tools to monitor how well the untrained neural network is converging towards the MLM 314, suitable to generating correct answers based on input data. In at least one embodiment, training server 360 trains untrained neural network repeatedly while adjusting weights to refine an output of untrained neural network using a loss function and adjustment algorithm, such as stochastic gradient descent. In at least one embodiment, training server 360 trains untrained neural networks until untrained neural network achieves a desired accuracy. In at least one embodiment, a trained neural network can then be deployed to implement any number of machine learning operations.

For example, initially, edge weights may be assigned some starting (e.g., random) values. For every training input 365, training engine 362 may cause each or some of MLMs 314 to generate output(s). Training engine 362 may then compare observed output(s) with the desired target output(s) 367. The resulting error or mismatch, e.g., the difference between the desired target output(s) 367 and the actual output(s) of the neural networks, may be back-propagated through the respective neural networks, and the weights in the neural networks may be adjusted to make the actual outputs closer to the target outputs. This adjustment may be repeated until the output error for a given training input 365 satisfies a predetermined condition (e.g., falls below a predetermined value). Subsequently, a different training input 365 may be selected, a new output generated, and a new series of adjustments implemented, until the respective neural networks are trained to an acceptable degree of accuracy.

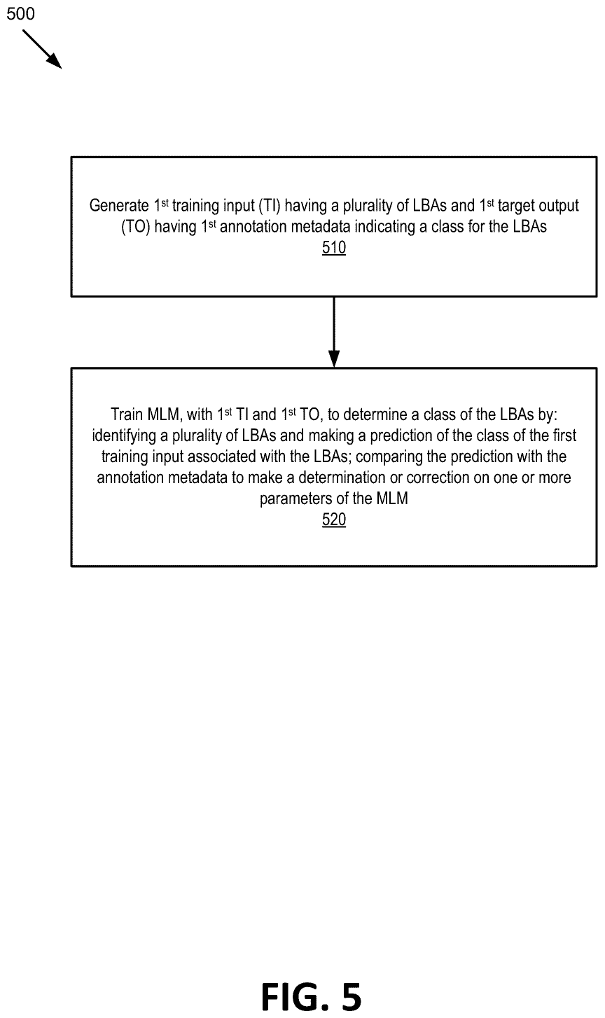

In some implementations, the MLM 314 may use logistic regression, support vector machines (SVM) algorithms or random forest for binary classification (e.g., long temporal metric class, short temporal metric class), or use naive Bayes, K-nearest neighbors, gradient boosting, SVM, or logistic regression for multi-class classification (e.g., long temporal metric class, medium temporal metric class, short temporal metric class). The details of training the MLM 314 for data placement optimization is illustrated with respect to FIG. 5.

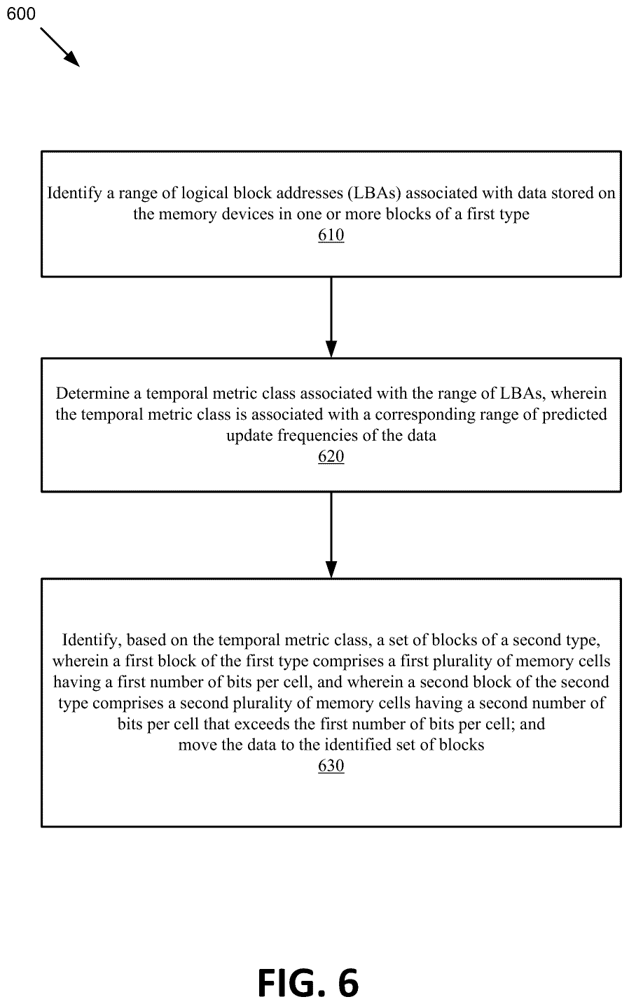

Data placement component 113 may host an inference engine 312 to run one or more MLMs 314 that has been trained. Inference engine 312 can use data (e.g., data 301) as input and apply the input to the MLM 314 that has been trained to determine the class of the LBAs of the data. The details of using the MLM 314 for data placement optimization is illustrated with respect to FIG. 6.

It is noted that although specific system architectures are shown in FIGS. 2-3, any or part of component or device in the system can be incorporated into other part of the system, separated into smaller components, or combined together, and the arrangement and number of the components and devices in the system and the communication among the components and devices can be modified as long as the end results according to the present disclosure are achieved.

FIG. 4 schematically illustrates example data placement in accordance with aspects of the present disclosure. The memory device 255 includes SLC blocks 254 and QLC blocks 256. Initially, the data stored in SLC blocks 254 may have the ranges of LBAs (e.g., LBA range 0, LBA range 1, LBA range 2, LBA range 3, . . . . LBA range N, LBA range N+1, LBA range N+2, LBA range N+3, . . . ). For each LBA, the memory device 255 (e.g., through the data placement component 113) may use a trained MLM to classify the LBA into a class (e.g., a binary class, or a multiple class). For example, as shown in the table 403, when the memory device 255 requests to move the data cached in the SLC blocks 254 to the QLC blocks 256, the trained MLM 314 can classify LBA range 0 as class C1, LBA range 1 as class C3, LBA range 2 as class C1, LBA range 3 as class C3, LBA range N as class C2, LBA range N+1 as class C1. In some implementations, class C1 can represent short temporal metric class, class C2 can represent medium temporal metric class, and class 3 can represent long temporal metric class. In some implementations, class C1 can represent long temporal metric class, class C2 can represent short temporal metric class, and class C3 can represent a class of parity data to check program failures (e.g., redundant array of independent NAND (RAIN)).

As shown in FIG. 4, according to the classes of the data, the memory device 255 may place the data with LBA 0, LBA 2, and LBA N+1 into a group (e.g., a superblock) Group 1 of the QLC blocks 256; the memory device 255 may place the data with LBA N into a group (e.g., a superblock) Group 2 of the QLC blocks 256; and the memory device 255 may place the data with LBA 1 and LBA 3 into a group (e.g., a superblock) Group 3 of the QLC blocks 256. Although the data represented by LBAs shown in FIG. 4 are uniform in size, and the groups of QLC blocks are also uniform in size, the data size associated with a LBA and the group size of the QLC array can vary.

FIGS. 5 and 6 are flow diagrams of example methods 500 and 600 of workload-specific data placement optimization in accordance with some embodiments of the present disclosure. The methods 500 and 600 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the methods 500 and 600 are performed by the data placement component 113 of FIGS. 1-3. Although shown in a particular sequence or order, unless otherwise specified, the order of the operations can be modified. Thus, the illustrated embodiments should be understood only as examples, and the illustrated operations can be performed in a different order, while some operations can be performed in parallel. Additionally, one or more operations can be omitted in some embodiments. Thus, not all illustrated operations are required in every embodiment, and other process flows are possible.

FIG. 5. is a flow diagram of an example method 500 of training machine learning models for use in data placement optimization, according to at least one embodiment. Method 500 may be performed to train MLMs for use in data placement optimization.

At operation 510, the processing logic may generate a first training data that may include a first training input and a first target output. The first training input may include a plurality of LBAs in the first training data. The first target output may include first annotation metadata that indicates a class of each of the plurality of LBAs (e.g., a binary class-long temporal metric class or short temporal metric class, a multi-class-long temporal metric class, medium temporal metric class, or short temporal metric class). The first training input may be one of a first set of training inputs. Similarly, the first target output may be one of a first set of target outputs.

At operation 520, the processing logic may provide the first training data to train a classification MLM. The classification MLM may identify a plurality of LBAs within the first training input and make a prediction of the class of the first training input associated with the LBAs and compare the prediction with the annotation metadata to make a determination or correction on one or more parameters of the MLM.

In at least one embodiment, during training, the MLM may select a plurality of features associated with LBAs. The selection may be made using a human input. In at least one embodiment, the selection may be made without any human input. The selected features may be features that are likely to be present in the data associated with the LBAs. Features may be selected by operator knowledge, rigorous testing, statistical analysis, or algorithmic methods. Algorithmic methods for selecting the features include sequential forward selection, sequential floating forward selection, sequential backward selection, and sequential floating backward selection.

In at least one embodiment, the processing logic may use the selected features to make a prediction of classes of the LBAs associated with the features. In some implementations, the processing units may predict the class using the selected features. The prediction may be in a form of probability, where the class, among all classes, which has the largest probability is the class the LBAs is predicted to belong to.

In at least one embodiment, the processing logic may, by comparing prediction with the annotation metadata, determine a mismatch between the prediction and annotation metadata. For example, predicted classes may not be completely accurate, compared with the information specified in the annotation metadata for the training signal, e.g., may have an error (mismatch) in excess of a maximum tolerance error. Responsive to determining that the maximum tolerance error is exceeded, the processing logic may update, based on the identified mismatch, the one or more parameters of the MLM. In at least one embodiment, the prediction may be updated in arbitrary (multiple) direction(s) and the updated prediction may be back-propagated through the MLM for the same training signal. Based on the results of (one or more of such) back-propagation(s), a derivative (or a gradient) of the loss function may be computed and a direction of the most favorable update may be selected. This process may be repeated until the mismatch with the prediction is minimized.

In some implementations, the processing logic may generate second (third, etc.) training data comprising a second (third, etc.) training input and a second (third, etc.) target output. The second (third, etc.) training input may include a second (third, etc.) training signal representing a first (second, etc.) plurality of features. The second (third, etc.) training data may further include the second (third, etc.) target output comprising second (third, etc.) annotation metadata that identifies the first (second, etc.) plurality of features. The second (third, etc.) training input may be one of a second (third, etc.) set of training inputs. Similarly, the second (third, etc.) target output may be one of a second (third, etc.) set of target outputs. In some implementations, the processing logic may provide the second (third, etc.) training data to train the MLM. After training that is based on the second (third, etc.) set of training inputs and the second (third, etc.) set of target outputs, the MLM may be able to classify the LBAs of the data.

FIG. 6 is a flow diagram of an example method 600 of using a trained machine learning model for data placement optimization, according to at least one embodiment.

At operation 610, the processing logic may identify a range of logical block addresses (LBAs) associated with data stored on the memory devices in one or more blocks of a first type. In some implementations, the processing logic may obtain a set of logical block addresses (LBAs) associated with data stored in one or more single-level cell (SLC) blocks of the memory. In some implementations, the data is associated with a hard disk drive experienced workload.

At operation 620, the processing logic may determine a temporal metric class associated with the range of LBAs, where the temporal metric class is associated with a corresponding range of predicted update frequencies of the data. In some implementations, the processing logic may input the range of LBAs to a machine learning model, and may output, from the machine learning model, a respective temporal metric class associated with the range of LBAs. In some implementations, the machine learning model is trained using data collected from a tiered storage stack comprising a solid-state drive (SSD) and a hard disk drive (HDD). In some implementations, the machine learning model is trained using historical data of a workload type, where the workload type is the same as a workload type of the data. In some implementations, the historical data comprises a range of LBAs, a time difference between updates associated with the update frequencies, and a size of data associated with the range of LBAs.

In some implementations, determining the respective temporal metric class associated with the range of LBAs is performed in view of a size of the data associated with the range of LBAs. For example, the size of data identified by the range of LBAs may exceed a threshold size, which may correspond to a long temporal metric class. In some implementations, determining the respective temporal metric class associated with the range of LBAs is performed in view of a time difference between writing and overwriting of the data associated with the range of LBAs. For example, time difference between writing and overwriting of the data identified by the range of LBAs may exceed a threshold time period, which may correspond to a long temporal metric class.

In some implementations, the temporal metric class comprises at least one of: a first class corresponding to a first time elapsed since most recent access to the data, the first time being below a threshold value; or a second class corresponding to a second time elapsed since most recent access to the data, the second time being not below the threshold value. In some implementations, the temporal metric class comprises at least one of: a first class corresponding to a first time elapsed since most recent access to the data, the first time being above a threshold value; or a second class corresponding to a second time elapsed since most recent access to the data, the second time being not above the threshold value.

In some implementations, the temporal metric class comprises at least one of: a first class corresponding to a first frequency of updates of the data, the first frequency being below a threshold value (e.g., a first range of frequency); or a second class corresponding to a second frequency of updates of the data, the second frequency being not below the threshold value (e.g., a second range of frequency). In some implementations, the temporal metric class comprises at least one of: a first class corresponding to a first frequency of updates of the data, the first frequency being above a threshold value (e.g., a third range of frequency); or a second class corresponding to a second frequency of updates of the data, the second frequency being not above the threshold value (e.g., a fourth range of frequency).

At operation 630, the processing logic may identify, based on the temporal metric class, a set of blocks of a second type, where a first block of the first type comprises a first plurality of memory cells having a first number of bits per cell, and where a second block of the second type comprises a second plurality of memory cells having a second number of bits per cell that exceeds the first number of bits per cell, and move the data to the identified set of blocks. In some implementations, the first number of bits per cell comprises a single bit per cell, and the second number of bits per cell comprises four bits per cell.

In some implementations, the processing logic may store the data in one or more groups of one or more non-single-level cell blocks of the memory device according to the respective temporal metric class. In some implementations, the data associated with a same temporal metric class is stored in a same group of the one or more groups of one or more non-single-level cell blocks. In some implementations, the one or more non-single-level cell blocks comprise one or more quad-level cell (QLC) blocks. In some implementations, the one or more non-single-level cell blocks comprise one or more multi-level cell (MLC) blocks. In some implementations, the one or more non-single-level cell blocks comprise one or more triple-level cell (TLC) blocks.

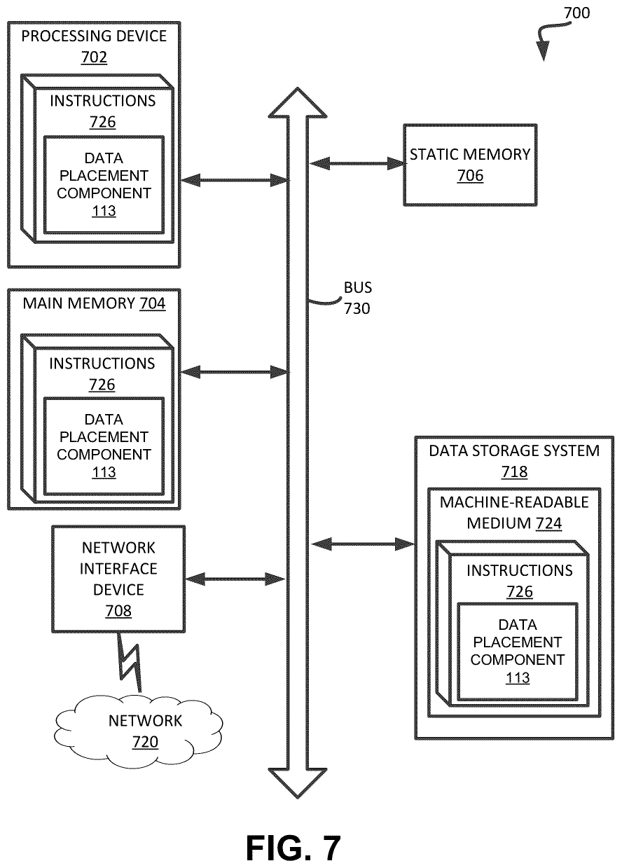

FIG. 7 illustrates an example machine of a computer system 700 within which a set of instructions, for causing the machine to perform any one or more of the methodologies discussed herein, can be executed. In some embodiments, the computer system 700 can correspond to a host system (e.g., the host system 120 of FIG. 1) that includes or utilizes a memory sub-system (e.g., the memory sub-system 110 of FIG. 1) or can be used to perform the operations of a controller (e.g., to execute an operating system to perform operations corresponding to data placement component 113 of FIGS. 1-3). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 700 includes a processing device 702, a main memory 704 (e.g., read-only memory (ROM), flash memory, dynamic random access memory (DRAM) such as synchronous DRAM (SDRAM) or Rambus DRAM (RDRAM), etc.), a static memory 706 (e.g., flash memory, static random access memory (SRAM), etc.), and a data storage system 718, which communicate with each other via a bus 730. Processing device 702 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 702 can also be one or more special-purpose processing devices such as an application specific integrated circuit (ASIC), a field programmable gate array (FPGA), a digital signal processor (DSP), network processor, or the like. The processing device 702 is configured to execute instructions 726 for performing the operations and steps discussed herein. The computer system 700 can further include a network interface device 708 to communicate over the network 720.

The data storage system 718 can include a machine-readable storage medium 724 (also known as a computer-readable medium) on which is stored one or more sets of instructions 726 or software embodying any one or more of the methodologies or functions described herein. The instructions 726 can also reside, completely or at least partially, within the main memory 704 and/or within the processing device 702 during execution thereof by the computer system 700, the main memory 704 and the processing device 702 also constituting machine-readable storage media. The machine-readable storage medium 724, data storage system 718, and/or main memory 704 can correspond to the memory sub-system 110 of FIG. 1.

In one embodiment, the instructions 726 include instructions to implement functionality corresponding to data placement component 113 of FIGS. 1-3. While the machine-readable storage medium 724 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system comprising:
a memory device; and
a processing device, operatively coupled to the memory device, to perform operations comprising:
identifying a set of logical addresses associated with data stored on the memory devices in one or more blocks of a first type;
determining a temporal metric class associated with the set of logical addresses, wherein the temporal metric class is associated with a corresponding range of predicted update characteristic of the data;
identifying, based on the temporal metric class, a set of blocks of a second type, wherein a first block of the first type comprises a first plurality of memory cells having a first number of bits per cell, and wherein a second block of the second type comprises a second plurality of memory cells having a second number of bits per cell that exceeds the first number of bits per cell; and
moving the data to the identified set of blocks.

2. The system of claim 1, wherein identifying the set of logical addresses and determining the temporal metric class are performed by a machine learning model trained to group host data by expected update frequency.

3. The system of claim 2, wherein the machine learning model is trained using data collected from a tiered storage stack comprising at least one of: a volatile memory device and a non-volatile memory device.

4. The system of claim 2, wherein the machine learning model is trained using historical data of a workload type same as a workload type of the data.

5. The system of claim 4, wherein the historical data comprises input/output commands with a set of logical addresses, a time difference between updates associated with the update characteristic, and a size of data associated with the set of logical addresses.

6. The system of claim 1, wherein the temporal metric class associated with the set of logical addresses is determined in view of a size of the data associated with the set of logical addresses.

7. The system of claim 1, wherein the temporal metric class associated with the set of logical addresses is determined in view of a time difference between updates associated with the update characteristic associated with the set of logical addresses.

8. The system of claim 1, wherein the first number of bits per cell comprises a single bit per cell, and wherein the second number of bits per cell comprises four bits per cell.

9. A method comprising:
identifying, by a processing device, a set of logical addresses associated with data stored on the memory devices in one or more blocks of a first type;
determining a temporal metric class associated with the set of logical addresses, wherein the temporal metric class is associated with a corresponding range of predicted update characteristic of the data;
identifying, based on the temporal metric class, a set of blocks of a second type, wherein a first block of the first type comprises a first plurality of memory cells having a first number of bits per cell, and wherein a second block of the second type comprises a second plurality of memory cells having a second number of bits per cell that exceeds the first number of bits per cell; and
moving the data to the identified set of blocks.

10. The method of claim 9, wherein identifying the set of logical addresses and determining the temporal metric class are performed by a machine learning model trained to group host data by expected update frequency.

11. The method of claim 10, wherein the machine learning model is trained using data collected from a tiered storage stack comprising at least one of: a volatile memory device and a non-volatile memory device.

12. The method of claim 10, wherein the machine learning model is trained using historical data of a workload type same as a workload type of the data.

13. The method of claim 12, wherein the historical data comprises a set of logical addresses, a time difference between updates associated with the update characteristic, and a size of data associated with the set of logical addresses.

14. The method of claim 9, wherein the first number of bits per cell comprises a single bit per cell, and wherein the second number of bits per cell comprises four bits per cell.

15. A non-transitory computer-readable storage medium comprising instructions that, when executed by a processing device operatively coupled to a memory, performs operations comprising:
identifying a set of logical addresses associated with data stored on the memory devices in one or more blocks of a first type;
determining a temporal metric class associated with the set of logical addresses, wherein the temporal metric class is associated with a corresponding range of predicted update characteristic of the data;
identifying, based on the temporal metric class, a set of blocks of a second type, wherein a first block of the first type comprises a first plurality of memory cells having a first number of bits per cell, and wherein a second block of the second type comprises a second plurality of memory cells having a second number of bits per cell that exceeds the first number of bits per cell; and moving the data to the identified set of blocks.

16. The non-transitory computer-readable storage medium of claim 15, wherein identifying the set of logical addresses and determining the temporal metric class are performed by a machine learning model trained to group host data by expected update frequency.

17. The non-transitory computer-readable storage medium of claim 16, wherein the machine learning model is trained using data collected from a tiered storage stack comprising at least one of: a volatile memory device and a non-volatile memory device.

18. The non-transitory computer-readable storage medium of claim 16, wherein the machine learning model is trained using historical data of a workload type same as a workload type of the data.

19. The non-transitory computer-readable storage medium of claim 18, wherein the historical data comprises a set of logical addresses, a time difference between updates associated with the update characteristic, and a size of data associated with the set of logical addresses.

20. The non-transitory computer-readable storage medium of claim 15, wherein the first number of bits per cell comprises a single bit per cell, and wherein the second number of bits per cell comprises four bits per cell.
